(19) United States
(12) Patent Application Publication
(10) Pub. No.: US 2012/0239566 A1
(43) Pub. Date: Sep. 20, 2012

(54) ASSET STORAGE AND TRANSFER SYSTEM FOR ELECTRONIC PURSES

(75) Inventor: David Everett, Rustington (GB)

(73) Assignee: ROYAL CANADIAN MINT/MONNAIE ROYALE CANADIENNE, Ottawa, ON (CA)

(21) Appl. No.: 13/496,698

(22) PCT Filed: Mar. 30, 2010
(86) PCT No.: PCT/CA2010/000435

§ 371 Date: May 29, 2012

Related U.S. Application Data
(60) Provisional application No. 61/243,203, filed on Sep. 17, 2009.

(51) Int. Cl. G06Q 20/36

(52) U.S. Cl. 705/41

(57) ABSTRACT

An electronic asset exchange system includes a communications medium and at least two electronic purses. Each electronic purse includes an interface configured to send and receive messages, a memory storing a current asset value amount, a respective unique identifier, and a log of asset transfers; and a controller. The controller receives an asset transfer message including at least an asset value amount to be transferred, and executes a Transfer-in process to increase the current asset value amount by the asset value amount to be transferred and record information of the asset transfer in the log. The controller receives, via the interface, an asset transfer request message including at least an asset value amount to be transferred, and executes a Transfer-out process to generate and send an asset transfer message including the asset value amount to be transferred, decreasing the current asset value amount by the asset value amount to be transferred; and recording information of the asset transfer in the log.

### CROSS-REFERENCE TO RELATED APPLICATIONS

This application is based on, and claims benefit of 61/243,203 filed Sep. 17, 2009, the entire contents of which is hereby incorporated herein by reference.

### MICROFICHE APPENDIX

Not Applicable.

### TECHNICAL FIELD

The present invention relates to a system for making payments by securely moving assets between the stores held by the participants in the system.

### BACKGROUND

Electronic payment systems are known in the art. A common example of such systems uses a “debit card” issued by a bank to its customers. In a simple transaction, the customer inserts their card into an automated teller machine (ATM), which uses information stored on the card to access the customer's account at the bank. The customer will often be required provide a secret Personal Identification Number (PIN) so that the bank may be assured of the authenticity of the card holder. Upon successful completion of the authentication process, the customer can request various types of transactions, such as cash withdrawals or transfers to another account.

Merchant's Point-of Sale (POS) devices may also be equipped to handle debit-card transactions. In this case, the debit card is inserted into a POS terminal, which uses information stored on the card to initiate a communication session with the customer's bank and send a message to the bank requesting the transfer of a sum of money from the customer's bank account to the merchant's bank account (at the same or a different bank). Upon successful completion of the bank's authentication process (again using the PIN), the bank will verify whether the customer's account contains sufficient funds, and if so the bank will execute the requested transaction.

Credit cards are often used in a directly analogous manner, but in the case of a credit card, the customer's account is a credit facility against which the customer is charged interest on any outstanding balance.

A problem with debit and credit cards is that banks and other card-issuing authorities often levy significant charges or fees for using the card. These fees may be charged to the cardholder, the merchant, or both, depending on the card-issuer's policies. Often, these fees are levied on a per-transaction basis, and significantly increase the costs of doing business for both merchants and card holders.

Another problem with the use of debit and credit cards is that transactions cannot normally be performed in an anonymous manner. The identities of both the card-holder and the merchant, are recorded by the card issuer as part of the transaction. While this provides a means of ensuring security and integrity of the system, it also enables the card issuer to compile a detailed record of the card-holder's purchasing history. This record can be mis-used in various ways, without the knowledge or (informed) consent of the card-holder. Accordingly, in many situations consumers would prefer to be able to make payments in an anonymous fashion.

A still further limitation of debit and credit cards is that the card-holder authentication process (entering of the PIN) slows down the process by which a transaction can be requested. This means that debit and credit cards are poorly suited to situation where it is desired to make a very small-valued transaction with minimum delay. Typical examples of such transactions include payment of a bus or subway fare.

What is required is an electronic payments system that more closely resembles the use of cash, in that it does not obviously incur costs when used for payments and enables a user to make anonymous transactions. A particular characteristic of cash is that it operates without reference to any third party, only the payer and the payee are involved in a particular transaction.

A further advantage of an electronic cash equivalent would be that such payments could be made remotely across wireless or cable networks in real time.

David Chaum addressed some of these issues in “Blind Signatures for Untraceable Payments,” D. Chaum, Advances in Cryptology Proceedings of Crypto 82, D. Chaum, R. L. Rivest, & A. T. Sherman (Eds.), Plenum, pp. 199-203. The idea behind Chaum's work was the concept of a blind digital signature that allowed the creation of electronic bills. A bank for example could create an electronic message protected by a digital signature that would represent the value of say a dollar bill. The digital signature would identify the bank as the issuer of the bill but not the consumer who gets the dollar bill from the bank. In order to make a payment to a merchant the consumer would need to give the merchant a set of these electronic dollar bills representing the cumulative value of the goods. It is clear that the consumer would also need electronic messages representing each coin value from 1 cent to a dollar in the US currency for example.

Apart from the difficulty of managing a suitable set of electronic bills it is clear that it would be easy for a fraudster to make copies of an otherwise genuine electronic dollar bill. It would not be possible to tell the difference between the original digitally signed message and a copy of this message so the system operates in such a way that the issuing bank only accepts the first copy of the bill presented, other copies, perhaps even the correctly authorized version would be rejected. In practice this means that Chaum's scheme has to operate on-line where the merchant can be connected to the issuing bank to be re-assured that payment will be made. Although the scheme looks like a local asset transfer system it cannot in practice be used that way because of the risk of fraud.

U.S. Pat. Nos 5,623,547 and 5,778,067 describe a system in which users are provided with electronic purses which can be used to store asset value. A bank (or other issuing authority) maintains a special bulk purse, to manage the total amount of asset value in circulation within the system. Asset value can be exchanged between the bulk purse and other purses, and between electronic purses, using a 4 message protocol where each message is digitally signed. This protocol is designed to ensure that duplicate payments are avoided. A limitation of this system is that both parties to a transaction must possess an electronic purse and the means to implement the electronic value transfer protocol. A further limitation is that the four message protocol increases the time required to make a value transfer, which might be unacceptable in some applications such as fare payment in a mass transit system, for example.

An electronic asset storage and transfer system that overcomes at least some of the limitations of the prior art remains highly desirable.

### SUMMARY

Accordingly, the present invention sets out to provide a practical way of achieving an electronic payment scheme more closely aligned with the use of cash in the physical environment but which is also capable of operating where the participants are remotely located only connected by some electronic cable or wireless interface. It is a particular feature of the invention that it can be used for micropayments without incurring substantial transaction fees. These micropayments relate particularly to the use of the internet and mobile phones where consumers might pay a few cents for electronic content such as music recordings or information which has content value.

Thus an aspect of the present invention provides an asset store and transfer system comprising: a plurality of electronic purses (e-Purses), each electronic purse including: a respective unique identifier; a memory for storing a current asset value and a log of asset transfer messages; and a controller for controlling transfers of asset value to and from the electronic purse. The controller transfers an asset value from the electronic purse by: generating and sending an encrypted asset value message including at least a selected asset value amount to be transferred from the electronic purse, the respective unique identifier of the electronic purse as payor, and a respective unique identifier of a payee; decreasing the current asset value by the selected asset value amount; and recording information of the asset transfer message in the log. The controller transfers an asset value to the electronic purse by: receiving an encrypted asset value message including at least a selected asset value amount to be transferred to the electronic purse; a respective unique identifier of a payor; and the respective unique identifier of the electronic purse as payee; decrypting the received asset value message; increasing the current asset value by the selected asset value amount; and recording information of the asset transfer message in the log.

According to the invention there is an asset transfer system involving a plurality of asset stores which represents the value of the assets of the owner held within the system. A particular participant in the system will have one or more stores of value assets. These stores are constructed in a secure environment such that it is not economically viable for a fraudster to manipulate the asset values held in the stores.

Attached to some of the stores of asset value is a processing device that allows the creation of a digitally signed asset value message which is associated with a decrease in value of the store to the same amount. When this asset value message is presented to the asset store for which it was intended the value of the store is increased by the same amount.

A feature of the asset transfer system is the way in which it prevents the replay of duplicate messages which might be used to defraud the system. The digitally signed message that is used to implement the asset transfer from one store to another has the particular property that it is unique and it is also contains information that identifies both the payer store and the payee store. The payer store also adds a nonce or additional information to ensure the message is unique. Each asset storage component includes a log that represents every asset value message created or received by that asset store in the currently valid security domain. The security domains in the asset stores may change from time to time as determined by the operators of the scheme. The transaction log of value messages may be reduced by using collision free hash functions in order to reduce the amount of memory required for storage and the time expended in testing for duplicate messages. In operation the processing device attached to the payee asset store checks that the asset value message has not already been acted upon before incrementing the value of its asset store.

In many practical payment scenarios the payee which for example could be a merchant may not have a locally held asset store. This is however not a problem of this system because the merchant would only require knowledge of the public key to check the digital signature of the asset value message and could also provide the payer asset store and processor with a nonce or other information to ensure the property of uniqueness in the digitally signed asset value message. These asset value messages can be sent to the remote asset store at a later point in time such that the merchant's terminal could operate in a total off-line mode without the need of handling secret cryptographic keys

The anonymity of electronic low value payment transactions in particular are difficult to achieve in practice. It is a characteristic of this system and other electronic payment systems that the payer entity is identified within the system. This is no different to the paper bills in national governments that provide currency. Each bill has a unique number so that in principle the government could detect duplicate counterfeit bills. This same number could of course be attached to a citizen when he receives the bill from say an ATM at a bank, the passage of the bill could be traced to a merchant and then through the merchant's bank but all this is generally deemed to not be practically viable.

The present invention can achieve at least the same properties of anonymity as cash by regularly changing the cryptographic keys used to generate the digital signatures of the asset transfer messages and even the identifier of the supporting asset stores. In addition there is no need for a citizen to be registered against an asset store. This is different to the use of debit or credit cards where the holder is effectively identified for each use of the card.

It can be seen that these asset transfer messages can operate in an anonymous fashion without the attendant banking costs normally associated with electronic payments in a way more associated with the use of cash. Users of the system will initially need to obtain the asset value from existing holders of asset value but once operating in this asset space the cost of transactions can be minimised or even be cost free depending on the business model of the system operators.

The asset transfer messages of the present invention are deemed to be irrevocable in that they operate the same way as cash. Once an asset store and processor has created a digitally signed asset transfer message the value in that asset store is reduced by the amount defined in the transfer message. Transactions cannot be cancelled nor can transfer messages be created for more value than is held in the store. In the event of a dispute the payer may choose to solicit a repayment from the payee by whatever means is deemed appropriate to both parties.

### BRIEF DESCRIPTION OF THE DRAWINGS

Further features and advantages of the present invention will become apparent from the following detailed description, taken in combination with the appended drawings, in which:

FIG. 1a is a block diagram schematically illustrating an asset value exchange system in accordance with an embodiment of the present invention;

FIG. 1b is a block diagram schematically showing principal elements of a e-Purse in accordance with an embodiment of the present invention;

FIGS. 2a and 2b are flow charts showing “Transfer-in” and “Transfer-out” processes in accordance with an embodiment of the present invention;

FIG. 3 is a block diagram schematically illustrating a value exchange system in accordance with embodiments of the present invention;

FIG. 4 is a message flow diagram schematically illustrating a process for transferring an desired asset value amount in a first scenario;

FIG. 5 is a message flow diagram schematically illustrating a process for transferring an desired asset value amount in a second scenario;

FIG. 6 is a message flow diagram schematically illustrating a process for transferring an desired asset value amount in a third scenario; and

FIG. 7 is a message flow diagram schematically illustrating a process for transferring an desired asset value amount in a fourth scenario.

It will be noted that throughout the appended drawings, like features are identified by like reference numerals.

### DETAILED DESCRIPTION

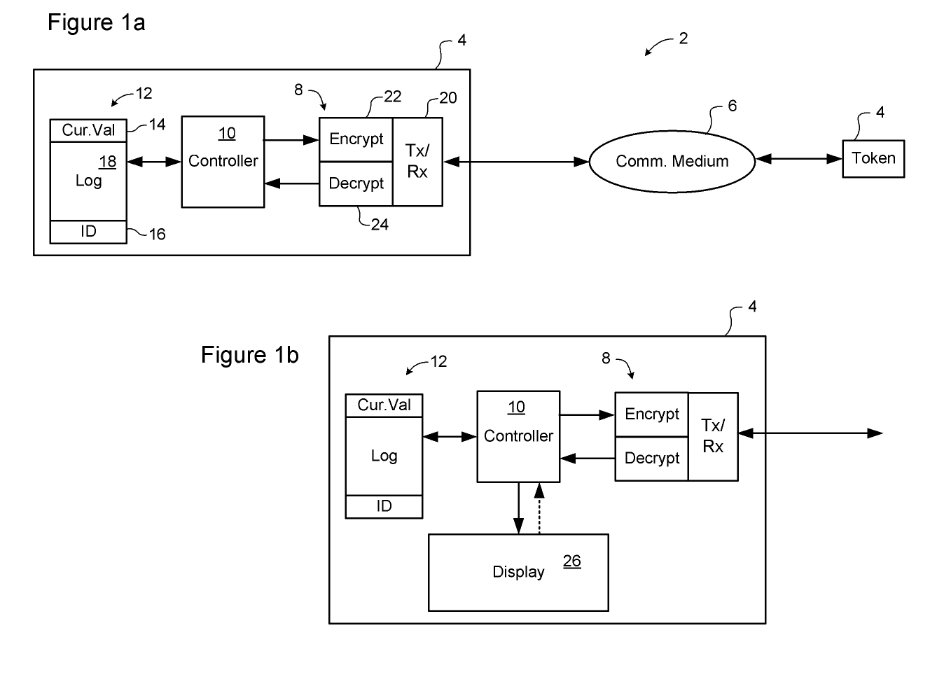

The present invention provides methods and apparatus for electronic asset storage and Transfer. Embodiments of the invention are described below, by way of example only, with reference to FIGS. 1-7.

Referring to FIG. 1a, in very general terms, an asset exchange system 2 in accordance with the present invention comprises at least two electronic-purses 4 configured to exchange messages through a communications medium 6. Each electronic-purse (e-Purse) 4 comprises an interface 8 configured to enable the e-Purse 4 to send and receive messages through the communications medium 6; a controller 10 responsive to received messages to record transfers of asset value to the e-Purse 4 and to transfer asset value from the e-Purse 4; and a memory 12 storing a current asset value (Cur.Val) 14, a respective unique identifier 16 of the e-Purse and a log 18 of asset transfers to and from the e-Purse 4e.

In addition to message transmission and reception functions 20, the interface 8 preferably also implements encryption 22 and decryption functions 24, such that messages sent by the e-Purse are digitally signed (encrypted) prior to being sent, and messages received by the e-Purse can be validated (decrypted). Encryption and decryption functions suitable for use in this manner are well known in the art.

As is known in the art, conventional Public Key Infrastructure (PKI) security systems operate by generating and assigning a pair of keys, which are commonly referred to as a “private” key and a “public” key, to each party. The private key is maintained in secrecy by the party, and is used to encrypt files prior to their being sent to another party. The public key is sent to the recipient, and enables them to decrypt the file. In some systems, the private key is not used to encrypt the file itself, but rather is used to apply a digital signature to the file. In this case, the public key enables the recipient to verify that the file has not been modified (or corrupted) prior to its arrival, and also provides the receiving party with a reason to believe that the file was actually sent from the alleged sending party.

In some embodiments, the encryption and decryption functions implemented by the interface 8 use the private key/public key system to digitally sign and verify asset value transfer messages sent and received by the e-Purse 4. In this case, each e-Purse 4 may be provided with a unique private key/public key pair, of which at least the public key is certified by a trusted Certification Authority in a manner known in the art. Known means can be used to store the keys such that it is impractical to discover the keys by reverse-engineering or hacking the e-Purse. In operation, the encryption function of the interface uses the “private” key to digitally sign asset value transfer messages sent by the e-Purse, and the decryption function uses the “public” key to verify asset value transfer messages received by the e-Purse. Asset value transfer messages sent by the e-Purse may also be accompanied by, or include, the e-Purse's public key certificate. By this means, an e-Purse receiving the asset value transfer message can first check the authenticity of the public key before checking the signature by possession of the public key.

In some embodiments, the e-Purse is implemented as a physical article. In such cases, the memory 12 is provided as a non-volatile random access memory (RAM), the controller 10 can be implemented as an integrated circuit operating in accordance with suitable firmware, and the interface 8 may be designed to enable communications via either electrical or wireless connections. If desired, the memory 12, controller 10 and at least the encryption/decryption functions 22, 24 of the e-Purse 4 can be implemented within a single Application Specific Integrated Circuit (ASIC). A physical e-Purse can be designed using any of a variety of suitable form-factors. For example, form factors commonly used for removable memory devices (including, but not limited to Memory-stick™, so-called “thumb-drive” devices) of computers and digital cameras may be used. Other suitable form-factors may be used, as desired, including smart cards and key-fobs, for example.

Referring to FIG. 1b, in some embodiments, a physical e-Purse may include a display 26 operatively connected to the controller 10, for displaying information such as, for example, the current asset value amount stored in memory 12. In some embodiments, the display 26 may be implemented as a so-called “touch screen”, which enables a user to input commands to the controller 10. Alternatively, buttons or switches may be provided on the physical e-Purse for this purpose. In such cases, the controller 10 may execute software implementing a graphical user interface (GUI) which enables a user to interact with the controller 10 to perform various functions including, but not limited to, displaying all or part of the log 18 of asset transfers stored in memory 12, displaying the current asset value amount stored in memory 12, and displaying a status of the e-Purse 4.

In the case of physical e-Purses having an electrical connector-type interface 8, it is anticipated that the configuration of the electrical connector will be selected based at least in part, on the form factor of the e-Purse as whole. For example, in some cases, a socket connector conforming to the Universal Serial Bus (USB) standard may be used. Other electrical connector configurations may be used, as desired. In the case of physical e-Purses having a wireless connection interface, it is preferable that the wireless connection be operative over a very limited distance (e.g. on the order of 10 cm or less), so as to reduce power requirements and enhance security. Various known radio-frequency electromagnetic or magnetic coupling techniques may be used to implement a wireless connection at this distance.

If desired, a battery may be used to provide at least some of the electrical power required by the various components of the physical e-Purse, in a manner well known in the art. Preferably, the interface 8 also provides a path for supplying power to the e-Purse to enable operation of the interface 8, controller 10 and memory 12. In the case of e-Purses having an electrical connector-type interface, it is a simple matter to provide ground and +Vdd contacts as part of the connector. In the case of e-Purses having a wireless connector-type interface, the interface preferably includes a rectifier for converting received wireless energy to electrical power in a manner known in the art. By suitable design of the interface 8, controller 10 and memory 12, power requirements of the e-Purse 4 can be made low enough that rectifying received wireless energy in this manner yields sufficient ectrical power for reliable operation of the e-Purse 4, either alone or in combination with battery power. Since the available power varies inversely as the square of the distance between the e-Purse 4 and a wireless terminal, this arrangement can serve as an effective means of limiting the maximum distance over which wireless connection to the e-Purse 4 can be made.

In some embodiments, the e-Purse 4 is implemented as a virtual e-Purse hosted by a secure server. In such cases, the memory may be implemented as a database record, while the server provides the interface 8 and controller 10 functionality using suitable software. Virtual e-Purses may be used by, for example, a broker as a means of managing multiple client accounts.

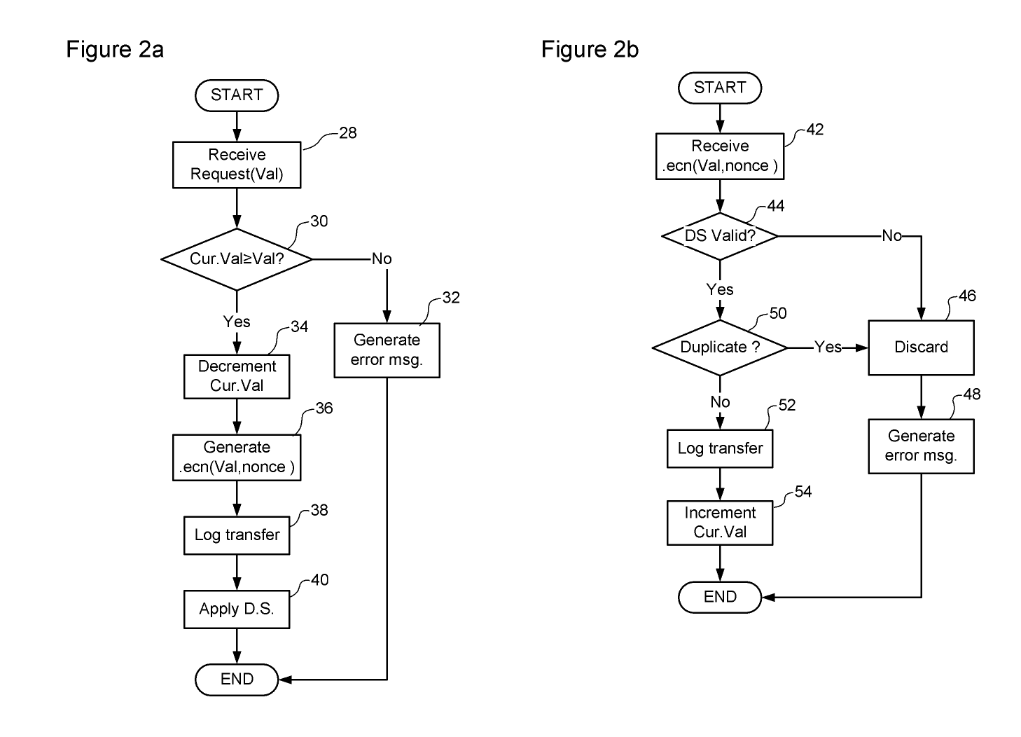

As noted above, the controller 10 is responsive to received messages to record transfers of asset value to the e-Purse 4 and to transfer asset value from the e-Purse 4. FIG. 2a is a flow-chart showing a representative “transfer Out” process which may be executed by the e-Purse to transfer asset value from the e-Purse. Referring to FIG. 2a, the transfer-out process begins with reception (at 28) of a request message containing the asset value amount (Val.) to be transferred. At a first step (at 30), the controller 10 compares the asset value amount (Val.) to be transferred to the current asset value (Cur.Val) 14 stored in the memory 12. If the current value 14 is less than the value amount to be transferred (Val.), then the controller 10 generates and returns an error message (at 32). Otherwise, the controller 10 decreases the current value (Curr.Val) stored in memory 12 by the amount (Val.) to be transferred (at 34), and then generates (at 36) a value transfer message containing the amount (Val.) to be transferred and a nonce which uniquely identifies the value transfer message, at least among the value transfer messages generated and sent by the controller 10. Finally, the controller 10 records information about the transfer in the log (at 38). In some embodiments, the nonce may be a counter value, the counter being incremented for each successive value transfer message. As noted above, the encryption function 22 of the interface 8 applies a digital signature to the value transfer message (at 40) and then transmits the signed value transfer message to the communications medium 6.

FIG. 2b is a flow-chart showing a representative “transfer In” process which may be executed by the e-Purse 4 to record a transfer of asset value to the e-Purse 4. Referring to FIG. 2b, the transfer-in process begins with reception of a value transfer message (at 42) containing the asset value amount to be transferred, and a nonce. At a first step, the decryption function 24 of the interface 8 uses the public key to verify (at 44) the digital signature of the received value transfer message. If the verification fails, the value transfer message is discarded (at 46), an error message is generated (at 48) and the transfer-in process is terminated. If the verification is successful, the controller 10 uses the nonce to compare (at 50) the received value transfer message with its log 18 to determine whether the value transfer message is a duplicate of a previously received message. If it is a duplicate, the value transfer message is discarded (at 46), an error message is generated (at 48) and the transfer-in process is terminated. Otherwise, the controller 10 records information about the transfer in the log (at 52), and increases the current value (Curr.Val) stored in memory 12 by the amount (Val.) to be transferred (at 54).

As noted above, the log 18 maintains a record of asset transfers into and out of the e-Purse 4. In some embodiments, the information recorded in the log 18 comprises the content of each asset transfer message received of sent by the e-Purse 4. In some embodiments, a digest of each asset transfer message may be recorded in the log 18, rather than the entire content. In some cases, the digest may take the form of a hash computed over at least a portion of the asset transfer message. Recording a hash of received value transfer messages, for example, enables effective detection of duplicate messages while minimizing the amount of memory required to store the log 18. In some embodiments, sent and received asset transfer messages may be recorded in respective separate logs. This arrangement is beneficial in that it facilitates respective different information sets to be recorded in each log 18. For example, the log of sent messages may record the entire content of every value transfer message sent by the e-Purse, while the log of received messages merely records a hash of each received message.

The above description with reference to FIG. 2 describes representative functions executed by the controller 10 to record received asset value and transfer asset value from the e-Purse 4. This description relates only to the specific functions executed by the e-Purse itself. This functionality can be used in various ways to effect asset value transfers between parties, as will be described in greater detail below.

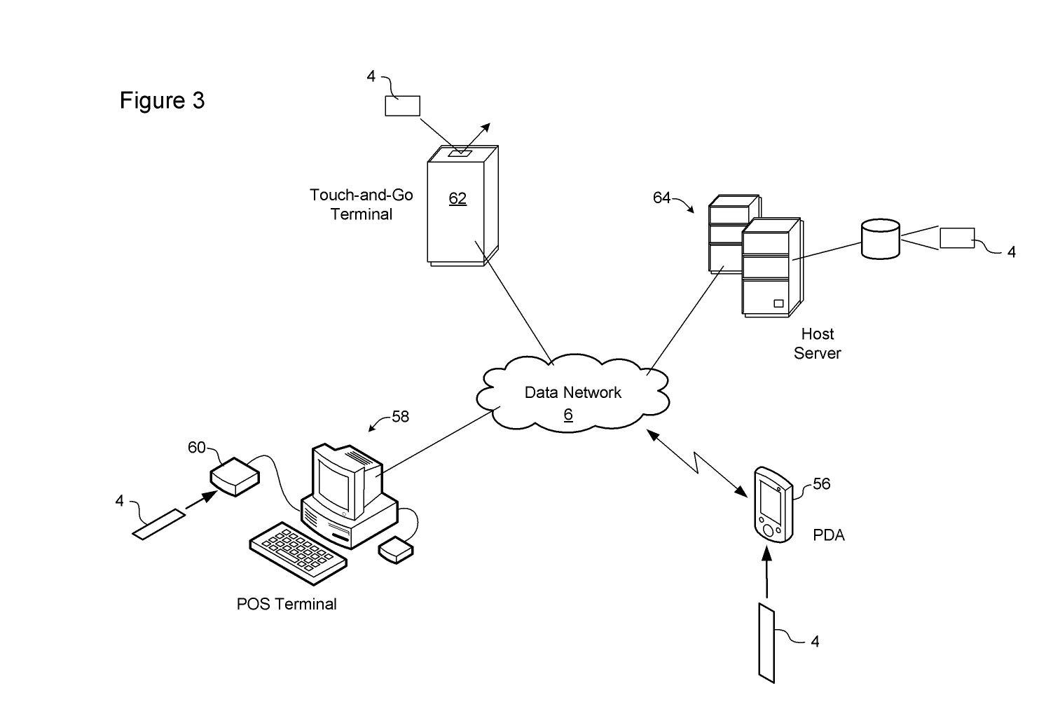

In general, the communications medium 6 can be any suitable combination of hardware and software capable of exchanging messages with the e-Purse 4. In embodiments in which the e-Purse is a virtual e-Purse hosted by a server, the communications medium may be a data network, such as the Internet. In embodiments in which the e-Purse is a physical article, the communications medium will normally be a communications device connected to the e-Purse via the interface, and connected to a data network for communications with other parties. FIG. 3 schematically illustrates a value exchange system which incorporates various representative types of communications devices and e-Purse form factors. In particular, FIG. 3 illustrates a user's personal communication device 56 such as a lap-top, personal data assistant (PDA) or cell-phone used with a physical e-Purse 4 (using either a wireless or electrical connector-type interface); a Point-of-Sale (POS) terminal 58 having a “reader” 60 for interfacing with a customer's physical e-Purse 4 (using either a wireless or electrical connector-type interface); a “touch-and-go” terminal 62 used with a physical e-Purse 4 having a wireless interface; and a host server 64 which instantiates and maintains a virtual e-Purse. Operation of each of these arrangements will be described in greater detail below.

In cases where the communications medium 6 is a user's personal communications device 56, the user's physical e-Purse may connect to the communications device 56 using either a wireless or electrical connector-type interface. In e-Purses having an electrical connector-type interface, the interface may be configured to plug into a suitable port of the communications device 56, either directly or via a suitable cable. USB ports are comparatively ubiquitous and can readily be used for this purpose, although any other suitable connector types may equally be used.

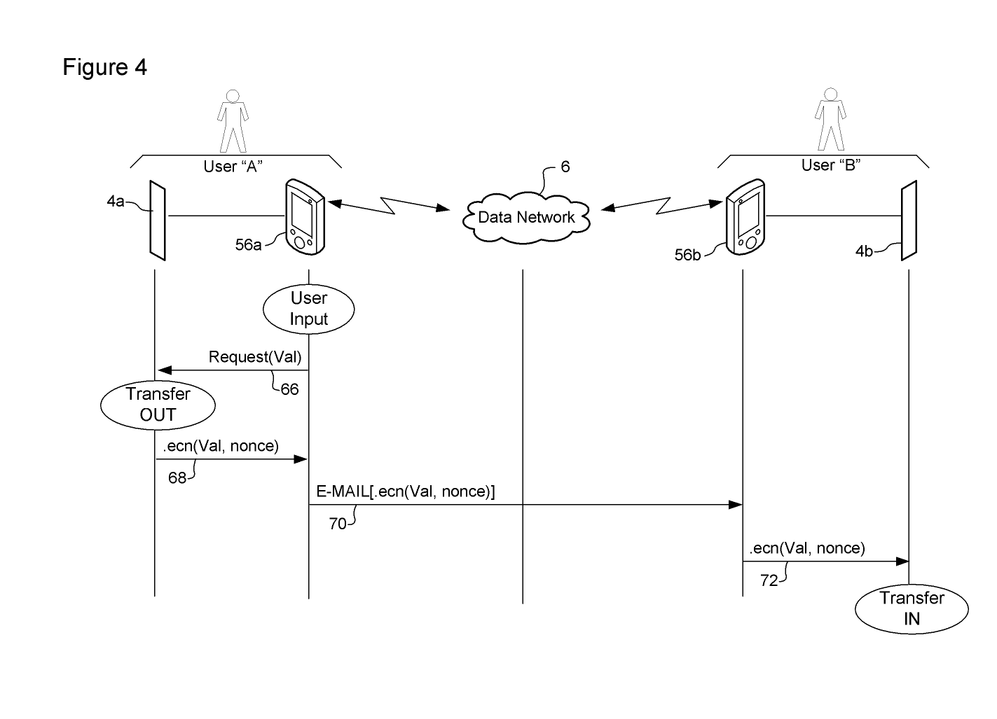

Preferably, a software application (or Applet) is installed on the user's personal communications device 56 to facilitate messaging to and from the e-Purse, and associated transfers of asset value, under control of the user. For example, FIG. 4 illustrates a scenario in which a desired asset value amount is transferred from a e-Purse 4a held by a first user (user “A), to a e-Purse 4b held by a second user (User“B”). In this scenario, User “A” may launch an applet on their personal communications device 56a, which opens a window on a display screen so that User “A” can enter information indicating the desired value amount that they wish to transfer to User “B”. Based on the input information, the Applet may generate a request message 66 containing the value amount to be transferred and send the request to User A's e-Purse via the interface. In response to the received request message, the e-Purse executes the “Transfer-Out” process as described above with reference to FIG. 2a. As noted above, following the “Transfer-Out” process, the e-Purse will return either an error message or a value transfer message 68 containing the value to be transferred. User A may then interact with the Applet to forward (at 70) the value transfer message through the data network to User B. For example, the value transfer message may be sent to User B as an attachment to an e-mail message. When User B receives (in their e-mail in-box, for example) an e-mail message containing the value transfer message, they may then interact with e-mail software and an Applet on their personal communications device 56b to forward the received value transfer message (at 72) to their e-Purse 4b, which then executes the “transfer-In” process described above with reference to FIG. 2b to record the transfer of asset value to the e-Purse 4b.

As may be appreciated, the above-described functionality can be used to transfer a desired asset value amount between any two physical e-Purses 4 hosted by respective communications devices 56 that are capable of exchanging messages through the data network 6. The use of e-mail to effect the message transfer is useful in that e-mail software is readily available and provides robust means for reliable and secure message transfer. It is also beneficial in that the message transfer does not need to be “real-time”, and the two parties do not need to establish a dedicated communications link in order to effect the transfer. However, the use of e-mail to effect message transfer is not essential. The sending e-Purse's current value is decremented by the amount being transferred at the time that the value transfer message is generated. The receiving party's e-Purse traps (and discards) duplicates, and increments its current value at the time the value transfer message is received. While these events can occur within the context of a single communications session, this it not necessary. It will also be seen that this operation closely follows the pattern of an exchange of cash legal tender (paper or coins), at least in the sense that it accomplishes an exchange of value between two parties, and does not involve or require the intervention of any third party (such as a bank).

The scenario described above with reference to FIG. 4 assumes that the two parties involved in the exchange of value are human users of their respective (physical) e-Purses 4 and their personal communications devices 56. However, it will be appreciated that this is not essential. For example, User A's e-Purse 4a could be a virtual e-Purse hosted by a remote server. In this case, User A may interact with a client application on the server to send the request message and obtain the desired value transfer message from their (virtual) e-Purse. Similarly, User B's e-Purse can be a virtual e-Purse hosted by a remote server. In this case, User B may interact with a client application on the server to forward the received asset value transfer message from their e-mail application to their (virtual) e-Purse.

Furthermore, it is not necessary for either or both of User A or User B to be human. For example, User A could be an automated system designed to forward payments to User B in accordance with a predetermined schedule. Similarly, User B could be an e-commerce application which receives and forwards the value transfer message to its (virtual) e-Purse as part of an on-line transaction, or any other type of automated payment processing system which receives and processes payments via the data network.

Thus it will be appreciated that the scenario described above with reference to FIG. 4 is equally applicable to the case of an asset transfer between two persons; an asset transfer between an person and an automated payment processing system; or an asset transfer between two automated systems.

In some embodiments, asset values stored on e-Purses may be treated as legal tender. In such cases, a user's bank may provide a facility whereby the user's bank account is represented by a virtual e-Purse. The user's physical e-Purse then can be used as an electronic wallet or purse. With this arrangement, the user can make cash withdrawals and deposits to and from their bank account by transferring asset value amounts between their virtual and physical and e-Purses using, for example, an automated teller machine configured to connect to the user's physical e-Purse, in a manner directly equivalent to conventional methods of cash withdrawal and deposit using a bank access card.

In some embodiments, asset values stored on e-Purses may be accepted as a means of storing and exchanging value, while not being legal tender. For example, e-Purse-based asset values may be treated as coupons or vouchers that are redeemable for merchandise or discounts at selected retailers. In another example, e-Purse-based asset values may be used as a means of value exchange for on-line transactions, such as within an on-line game or social networking environment. In both such cases, a user may purchase a e-Purse with a given asset value amount already stored in its memory 12. Alternatively, a user may purchase a desired asset value amount, for example from a broker, which is transferred to a e-Purse already in the user's possession (e.g. using the method described above with reference to FIG. 4). It is anticipated that a user may also sell some or all of the asset value amount stored on the user's e-Purse to a broker in exchange for legal tender. In this way, brokers can serve as a means by which users can convert legal tender into e-Purse based asset value, and vise versa.

As noted above, in embodiments in which the communications medium is a user's personal communications device (such as a lap-top, PDA or a cell-phone), an applet can be executed on the interaction between the personal communications device to facilitate interaction with the e-Purse. In some embodiments, this applet may be installed on the personal communications device, and launched as desired by the user. In some embodiments, the applet may be launched automatically, for example in response to detection (by the personal communications device) that the e-Purse has been connected to one of the device's I/O ports. In other embodiments, the applet may be stored on the e-Purse itself, and automatically uploaded and launched on the personal communications device when the e-Purse is connected to an I/O port of the personal communications device

In embodiments in which the e-Purse is a virtual e-Purse hosted on a remote server, the applet may take the form of a browser application or “plug-in” that enables the user to interact with their virtual e-Purse via web-browser software.

As noted above, the “Transfer-Out” process returns an error message if the desired amount to be transferred exceeds the current value stored in the e-Purse. Similarly, the “Transfer-In” process may return an error message if the received value transfer message is a duplicate. Preferably, the applet used to interact with the e-Purse is designed to display appropriate warnings and/or prompts to a user in response to these error messages. In some embodiments, additional messages may be exchanged between the applet and the e-Purse, to facilitate use of the e-Purse by a user.

For example, when the applet is launched on the user's personal communications device, it may automatically send a status request message to the e-Purse. In response, the e-Purse may return a status check message which includes the current asset value stored in the e-Purse. Upon receipt of the status check message, the applet may display the current asset value on a display of the user's personal communications device. If no response is received within a predetermined time, the applet may determine that the e-Purse is either not connected or not functioning properly, and display an appropriate warning on the display of the personal communications device.

If desired, the applet may also enable the user to send a log record request message to the e-Purse, in response to which the e-Purse returns a log record message containing the contents of the log stored in the e-Purse's memory 12. In some embodiments, the applet may further enable this log record message, or the log contents within it, to be uploaded to an accounting application so that the user may maintain a personal record of their expenditures.

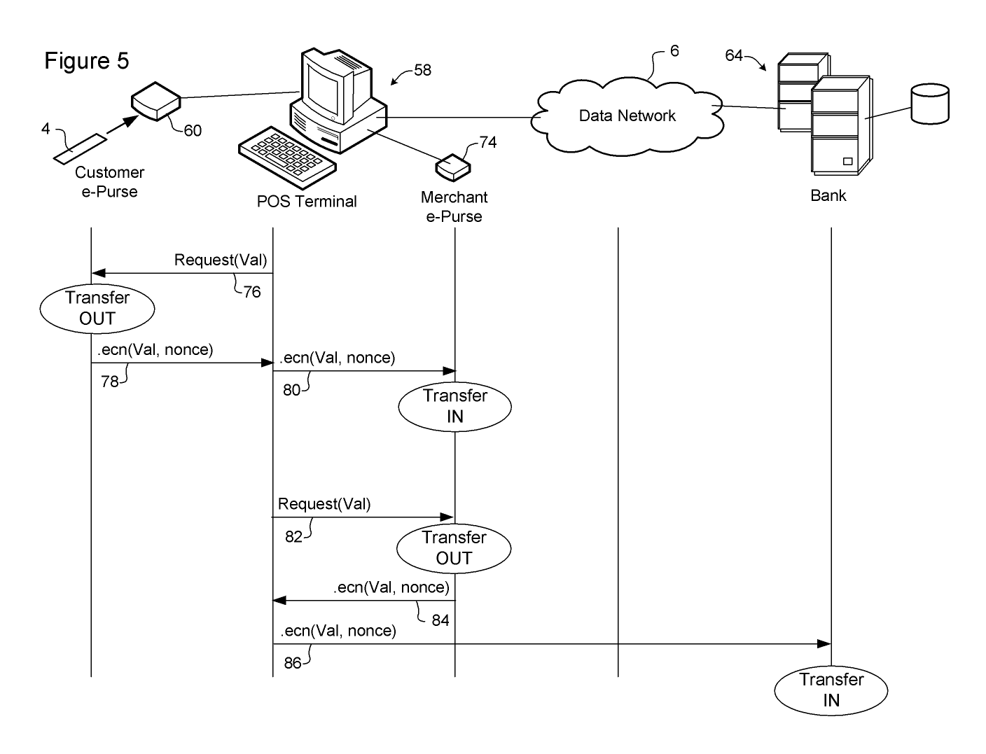

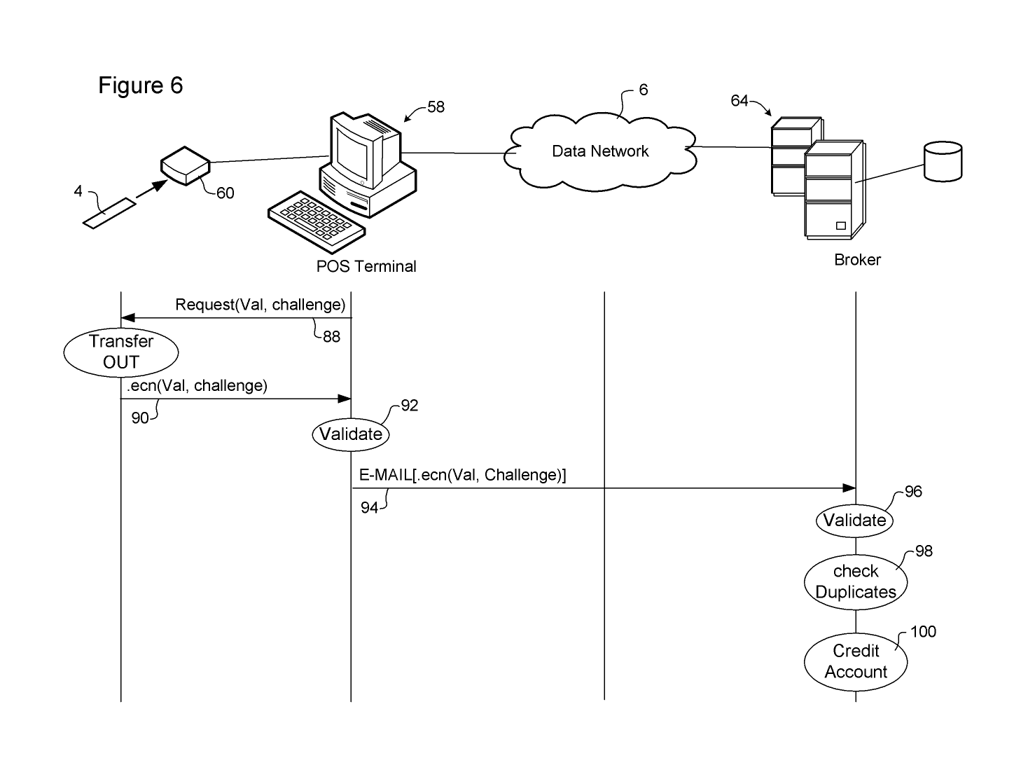

FIGS. 5 and 6 show respective message flows for handling asset value transfers between a customer and a merchant, for example as part of a purchase transaction.

The message flow of FIG. 5 relates to a scenario in which a Point of Sale (POS) terminal 58 is used to transfer a desired asset value amount from an e-Purse held by a customer, to a local e-Purse 74 held by the merchant.

As may be seen in FIG. 5, the POS terminal 58 includes a reader device 60 designed to establish a connection between the POS terminal 58 and the customer's physical e-Purse 4 using either a wireless or electrical connection. The merchant's local e-Purse 74 may be provided as a peripheral device connected to an I/O port of the POS terminal 58. If desired, the merchant's local e-Purse 74 may by used to support asset value transfers controlled by a single POS terminal 58, or a cluster of two or more POS terminals at a given retail location, for example. The merchant's local e-Purse 74 can be a physical device connected to the POS terminal 58 as shown in FIG. 5, or may be a virtual e-Purse hosted on a remote server. In the case of a virtual e-Purse, the POS terminal 58 may be designed to interact with the e-Purse via a secure link to the remote server, for example using a browser application.

The POS terminal 58 executes an application which allows the merchant to enter purchase amounts in a conventional manner, and calculate a total asset value to be transferred from the customer's e-Purse. The POS application may then generate a request message (at 76) containing the value amount to be transferred and send the request to the customer's e-Purse 4 via the reader device 60. In response to the received request message, the customer's e-Purse 4 executes the “Transfer-Out” process as described above with reference to FIG. 2a. As noted above, following the “Transfer-Out” process, the customer's e-Purse 4 will return (at 78) either an error message or a value transfer message containing the value to be transferred. Upon receipt of the value transfer message, the POS application may then forward (at 80) the received value transfer message to the merchant's local e-Purse 74, which then executes the “transfer-In” process described above with reference to FIG. 2b to record the transfer of asset value. Naturally, if it is desired to refund an amount to the customer, this process can be reversed.

As may be appreciated, this arrangement enables the POS terminal 58 to perform all of the normal cash-sale operations of a conventional POS terminal, using asset value amounts stored in customers' e-Purses rather than cash legal tender. The log stored in the memory of the merchant's local e-Purse 74 contains a complete record of electronic asset value transactions, which can be retrieved by the merchant and used for record keeping and accounting purposes, as desired.

It is anticipated that a merchant may desire to provide its customers with physical e-Purses 4, and use e-Purse-based asset value transactions in a manner directly analogous to the conventional use of coupons or vouchers that are redeemable for merchandise or in-store discounts. In such cases, the physical e-Purses 4 provided by the merchant may be configured such that they will only recognise and interact with the merchant's POS terminals 58. This selective operation may be accomplished by various means including, but not limited to: designing the e-Purses 4 with a proprietary interface 8; designing the e-Purses 4 with a proprietary encryption algorithm or pair of keys unique to the merchant; and configuring the controller 10 such that it will only respond to request messages that include a predetermined code-word that is known only to the merchant. For example, each of the transfer-in and transfer out processes of FIG. 2 may be modified to include steps of checking received messages for the presence of a code-word, and if it is found, determining whether or not the code-word is valid (for example by comparing it to a value previously stored in memory 12). If the code-word is found to be valid, the rest of the transfer-in and transfer out processes proceed normally. If the code-word is found to be invalid, an error message may be sent, and the transfer-in and transfer out processes terminate.

In embodiments in which e-Purse-based asset values are recognized as legal tender, the merchant may desire to transfer some or all of the asset value amount stored on their local e-Purse to their bank account. Thus, referring back to FIG. 5, the merchant can interact with their POS terminal to enter the amount to be transferred. The POS terminal then generates and sends (at 82) an appropriate request message containing the entered amount to the merchant's local e-Purse 74, which responds by returning a value transfer message (at 84) to the POS terminal 58 in the manner described above with reference to FIG. 2a. This value transfer message can then be sent (either automatically, or in response to user input to the POS terminal) to the merchant's virtual e-Purse which has previously been set up to represent their bank account, which results in the deposit of the asset value amount in the merchant's bank account.

In embodiments in which e-Purse-based asset values are not recognized as legal tender, the merchant may desire to sell some or all of the asset value amount stored on their local e-Purse 74 to a broker, in exchange for legal tender. Substantially the same method as described above can be used to perform this transaction, but in this case, the value transfer message returned by the merchant's local e-Purse 74 (at 84) may be sent to the broker as an attachment to an e-mail, and the broker may then use conventional methods of electronic funds transfer to deposit an amount of legal tender into the merchant's bank account as part of the transaction.

In the embodiments described above with reference to FIG. 5, asset value amounts transferred from customers' e-Purses 4 are stored in the merchant's local e-Purse 74, and then some or all of this stored asset value is subsequently sent to the merchant's bank account (virtual e-Purse) or a broker for conversion to legal tender. In some cases, this arrangement is useful in that successful completion of the transfer-in process by the merchant's local e-Purse 74 provides immediate confirmation that the intended asset value amount has been transferred to complete the purchase transaction. However, the need to set up and manage one or more local e-Purses 74 may be undesirably inconvenient for the merchant. FIG. 6 illustrates an embodiment which avoids this difficulty.

In the embodiment of FIG. 6, the merchant contracts with a broker who provides asset transfer services. The merchant's POS terminal 58 is then provided with the public key and a software application that enables the POS application to verify asset transfer messages returned from customers' e-Purses 4. During a purchase transaction, the merchant enters purchase amounts in a conventional manner, and calculates a total asset value to be transferred from the customer's e-Purse 4, all in the same manner as described above with reference to FIG. 5. The POS application then generates a request message (at 88), which in this case contains the value amount to be transferred and a challenge word. The challenge word can be any alphanumeric string that is unique, at least among the asset value transfer request messages sent by the POS terminal 58. When the request message is received by a customer's e-Purse 4, it executes the “Transfer-Out” process as described above with reference to FIG. 2a, and upon successful completion returns (at 90) a value transfer message containing at least the value to be transferred, the challenge word and a unique identifier of the customer's e-Purse. In some embodiments, the returned value transfer message may also include a nonce generated by the customer's e-Purse 4 to enable detection of duplicate messages by the broker. In other embodiments, the challenge word may be used for this purpose, in which case the nonce generated by the customer's e-Purse 4 may only be used in the e-Purse's log 18, and the returned value transfer message will not include the nonce. Upon receipt of the value transfer message, the POS application can check the digital signature (at 92) to verify the value transfer message, and examine the challenge word. If the verification is successful and the returned challenge word matches that sent to the customer's e-Purse 4, then the merchant can conclude that the customer's e-Purse 4 is operating properly, and has issued a valid value transfer message. The (encrypted/signed) value transfer message can then be forwarded (at 94) from the POS terminal to the broker, for example as an attachment to an e-mail. Upon receipt of the value transfer message, a broker application verifies the value transfer message (at 96); checks the e-Purse identifier and nonce (at 98) to detect duplicate copies of the value transfer message, and then credits the asset value amount in the value transfer message to the merchant's account (at 100). This latter operation may be performed either by transferring the asset value amount to a virtual e-Purse representing the merchant's bank account, or a conventional electronic funds transfer of legal tender to merchant's bank account, as desired.

In the embodiments described above with reference to FIGS. 5 and 6, a purchase transaction is controlled by a POS terminal 58, for example at a merchant's retail outlet. However, it will be appreciated that substantially identical processes can be used to handle transactions at a “touch-and-go” terminal 62, for example to handle a transit fare payment at a bus or sub-way terminal. In this case, however, the value amount to be transferred is known in advance, so that the “touch-and-go” terminal 62 can send the transfer request message immediately upon detection that a e-Purse 4 has successfully connected to its interface. Generation of the value transfer message by the e-Purse 4, and subsequent handling of the value transfer message can be substantially identical to that described above with reference to FIGS. 5 and 6, with the “touch-and-go” terminal operating automatically in place of the manually operated POS terminal 58. In both of these scenarios, the “touch-and-go” terminal verifies the value transfer message returned by the e-Purse 4. If desired, this verification step may be used to control a turnstile or other restricted access system, so that a user of the e-Purse is prevented from proceeding if the asset value transfer fails.

An advantage of this arrangement is that the “touch-and-go” terminal can issue the transfer request message, and receive and verify the returned asset value transfer message within a very short period of time. In many cases, this will enable commuters at a sub-way station, for example, to pay their transit fare without incurring any significant delay, thereby maximizing the convenience for the commuter, while at the same time minimizing the transaction costs incurred by the transit authority.

As described above, in some embodiments a merchant may use a proprietary code-word to enable selective operation of e-Purses, for example to facilitate use of e-Purse-based asset values as vouchers or coupons redeemable for merchandise or discounts. This same principle can be applied to define communities of interest, and enable a given e-Purse to exchange asset value amounts only with other e-Purses within that community of interest. For example, consider an example in which asset value amounts are (at least nominally) denominated in the currency of a given country. It would be desirable to limit the exchange of asset value amounts between e-Purses whose asset values are denominated in that same currency. Thus, a community of interest may be defined for asset values denominated in British Pounds, and another community of interest defined for asset values denominated in Canadian Dollars. The e-Purses used in both communities of interest may be identical, but exchanges of value restricted to each community of interest by issuing respective different code-words (which in this example would take the form of currency indicators) to each community. With this arrangement, an asset value transfer message issued by a e-Purse within the “Canadian Dollars” community of interest could not be successfully received and processed by a e-Purse within the “British Pounds” community of interest, for example. If desired, a user could acquire e-Purses for two or more communities of interest, and transfer asset value amounts between them (and so effectively completing a currency exchange transaction), using a broker who provides that service. As may be appreciated, the denomination of asset values in terms of the legal currency of a given nation provides a convenient method of representing asset value amounts, independently of whether or not e-Purse-based asset values are considered to be legal tender. Thus the foregoing example is not limited to cases in which e-Purse-based asset values are considered to be legal tender. Furthermore, it will be appreciated that the use of communities of interest is not limited to preventing transfers between e-Purses whose asset values are denominated in different national currencies. Rather any desired criteria may be used to define a community of interest, and limit e-Purses within that community of interest to asset value transfers with other e-Purses within that community of interest.

In the embodiments described above with reference to FIGS. 2-6, an e-Purse receives a transfer request message containing an asset value amount to be transferred, and returns either an error message or an asset value transfer message containing the asset value amount to be transferred. In some cases, this operation may be undesirable, because a user must either employ their own communications device 56 to generate the transfer request message (as illustrated in FIG. 4), or else trust that the other party (e.g. a merchant's POS system 58 or Touch-and-go terminal 62) provides a request message with the correct amount of asset value to be transferred. In embodiments in which a physical e-Purse includes a display 26 and a user input device (such as a touch-screen), as described above with reference to FIG. 1b, this limitation can be overcome by configuring the controller 10 to accept a user input of the amount to be transferred. When the e-Purse subsequently receives the transfer request message (e.g. from a POS terminal, as shown in FIGS. 5 and 6), the controller 10 can compare the value amount contained in the request message with the amount input by the user. If the two amounts match, then the controller 10 executes the Transfer-out process to transfer the requested amount, as described above. Otherwise, the controller 10 can either ignore the received request message, or transmit an error message.

In an alternative scenario, a POS terminal can be configured to generate a transfer request message containing a “null” value for the asset value amount to be transferred. In this scenario, the controller 10 would the execute the Transfer Out process largely as described above, but inserting the asset amount input by the user into the value transfer message rather than using the value contained in the transfer request message, In this case, the POS application executing on the POS terminal 58 can compare the asset value amount contained in the asset transfer message to the total amount required to be paid. If these two values match, the POS application can issue a receipt to the customer to complete the sale transaction. If desired, the POS terminal 58 can be configured to generate a “null” transfer request message automatically upon detection of the customer's physical e-Purse 4 by the reader 60. This operation results in an exchange which proceeds in a manner that very closely follows a conventional cash sale transaction, in which the POS terminal calculates a total sale price, the customer then offers cash to the sales clerk, and the sale transaction is completed when the amount offered by the customer matches the total sale price calculated by the POS terminal. As a result, the advantages of and familiarity of conventional cash sales transactions are obtained, but without the inconvenience of having to handle paper and coin legal tender

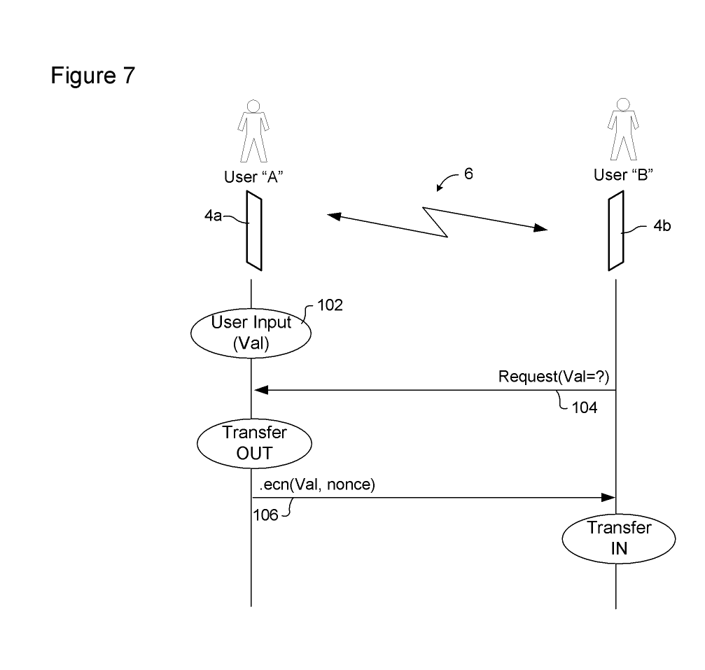

FIG. 7 illustrates a scenario in which a desired asset value amount is transferred from a physical e-Purse 4a held by a first user (user “A), directly to a physical e-Purse 4b held by a second user (User“B”). In this scenario at least user A's e-Purse 4a includes a display 26 and a user input device (such as a touch-screen), and both e-Purses are provided with a wireless interface. Referring to FIG. 7, User “A” inputs an amount to be transferred (at 102), and then positions their e-Purse 4a into close proximity to User B's e-Purse 4b. When the two e-Purses are close enough to establish a wireless link, User B's e-Purse 4b transmits a transfer request message (at 104) having a null value for the amount to be transferred. Upon receipt of the “null” transfer request message, User A's e-Purse 4a executes the Transfer-out process, as described above, to generate (at 106) an asset transfer message which contains the amount to be transferred that was previously input by User A. When User B's e-Purse 4b receives the value transfer message, it automatically executes the “transfer-In” process as described above to record the transfer of asset value to the e-Purse.

This scenario is particularly suitable for voluntary asset transfers between two people, such as, for example, in the case of a customer wishing to tip a bell-hop in a hotel. As described above, User A initiates the value transfer, and selects the amount to be transferred. User A also controls the recipient, by placing their e-Purse in close proximity with the e-Purse to which the selected asset value amount is to be transferred. In this case, security of the transfer is maintained because User A's e-Purse 4a will only respond to a received transfer request message containing a null value after the amount to be transferred has been entered, and then will only transmit a single asset transfer message in response to a received transfer request message. Furthermore, the asset transfer will only occur once the two e-Purses have been brought into close proximity. As a result, the probability of unwanted asset transfers from User A's e-Purse is extremely low.

In the scenario of FIG. 7, user B's e-Purse 4b responds to the presence of user A's e-Purse by transmitting a transfer request message. This function requires that user B's e-Purse be able to detect the presence of User A's e-Purse 4a within range of its wireless interface. Various methods may be used to accomplish this. For example, once user A has entered the amount to be transferred, user A's e-Purse may begin to transmit a predetermined hand-shake signal. User B's e-Purse may then respond to detection of the handshake signal, by generating the transfer request message. Other techniques will be apparent to those of ordinary skill in the art and may be used without departing from the intended scope of the appended claims.

The embodiment(s) of the invention described above is(are) intended to be exemplary only. The scope of the invention is therefore intended to be limited solely by the scope of the appended claims.

We claim:

1. An electronic asset exchange system comprising:
a communications medium;
at least two electronic purses, each electronic purse comprising:
an interface configured to send and receive messages through the communications medium;
a memory storing at least a current asset value amount, a respective unique identifier, and a log of asset transfers; and
a controller operatively coupled to the interface and the memory, the controller operating under control of instruction code to:
receive, via the interface, an asset transfer message including at least an asset value amount to be transferred, and execute a Transfer-in process to record a corresponding transfer of asset value to the electronic purse, the Transfer-in process including steps of: determining whether the received asset transfer message is a duplicate, and if it is not a duplicate increasing the current asset value amount by the asset value amount to be transferred and recording information of the asset transfer in the log; and
receive, via the interface, an asset transfer request message including at least an asset value amount to be transferred, and execute a Transfer-out process to record a corresponding transfer of asset value from the electronic purse, the Transfer-out process including steps of determining whether the current asset value amount is equal to or greater than the asset value amount to be transferred, and if it is, then generating and sending an asset transfer message including the asset value amount to be transferred, decreasing the current asset value amount by the asset value amount to be transferred; and recording information of the asset transfer in the log.

2. The electronic asset exchange system as claimed in claim 1, wherein each electronic purse comprises any one of:
a physical electronic purse; and
a virtual electronic purse instantiated and maintained by a server.

3. The electronic asset exchange system as claimed in claim 1, wherein the communications medium comprises any one or more of:
a network;
a communications device connected to the network and connected to the electronic purse via the interface, the communications device hosting the electronic purse for communications through the network; and
a direct link between the electronic purse and a point of sale terminal or another electronic purse.

4. The electronic asset exchange system as claimed in claim 3, wherein the network is the internet.

5. The electronic asset exchange system as claimed in claim 3, wherein the communications device is selected from the list comprising Personal Data Assistants (PDAs); cell phones, hand-held computers and lap-top computers.

6. The electronic asset exchange system as claimed in claim 3, wherein the direct link is a wireless link.

7. The electronic asset exchange system as claimed in claim 3, wherein the point-of sale terminal is selected from the list comprising merchant's point-of-sale devices, self-service kiosks and “touch-and-go” terminals.

8. The electronic asset exchange system as claimed in claim 1, wherein each asset transfer message comprises a respective digital signature, which is unique at least among asset transfer messages generated by a given electronic purse.

9. The electronic asset exchange system as claimed in claim 8, wherein the transfer-in process further comprises processing the respective digital signature of each received asset transfer message to determine a validity of the received asset transfer message.

10. The electronic asset exchange system as claimed in claim 9, wherein the transfer-in process further comprises discarding the received asset transfer message if it is determined to be invalid.

11. The electronic asset exchange system as claimed in claim 1, wherein the transfer-in process determines whether the received asset transfer message is a duplicate by comparing the received asset transfer message to information of previously received asset transfer messages recorded in the log.

12. The electronic asset exchange system as claimed in claim 1, wherein the transfer-in process further comprises discarding the received asset transfer message if it is determined to be a duplicate.

13. The asset store and transfer system as claimed in claim 1, wherein the information recorded in the log comprises a digest of each asset transfer message.

14. The asset store and transfer system as claimed in claim 13, wherein the digest comprises a hash of the respective asset transfer message.

15. An apparatus for storing and transferring asset value, the apparatus comprising:
an interface configured to send and receive messages through a communications medium;
a memory storing at least a current asset value amount, a respective unique identifier, and a log of asset transfers; and
a controller operatively coupled to the interface and the memory, the controller operating under control of instruction code to:
receive, via the interface, an asset transfer message including at least an asset value amount to be transferred, and execute a Transfer-in process to record a corresponding transfer of asset value to the electronic purse, the Transfer-in process including steps of: determining whether the received asset transfer message is a duplicate, and if it is not a duplicate increasing the current asset value amount by the asset value amount to be transferred and recording information of the asset transfer in the log; and
receive, via the interface, an asset transfer request message including at least an asset value amount to be transferred, and execute a Transfer-out process to record a corresponding transfer of asset value from the electronic purse, the Transfer-out process including steps of determining whether the current asset value amount is equal to or greater than the asset value amount to be transferred, and if it is, then generating and sending an asset transfer message including the asset value amount to be transferred, decreasing the current asset value amount by the asset value amount to be transferred; and recording information of the asset transfer in the log.

16. The apparatus as claimed in claim 15, wherein each asset transfer message comprises a respective digital signature, which is unique at least among asset transfer messages generated by a given electronic purse.

17. The apparatus as claimed in claim 16, wherein the transfer-in process further comprises processing the respective digital signature of each received asset transfer message to determine a validity of the received asset transfer message.

18. The electronic asset exchange system as claimed in claim 17, wherein the transfer-in process further comprises discarding the received asset transfer message if it is determined to be invalid.

19. The apparatus as claimed in claim 15, wherein the transfer-in process determines whether the received asset transfer message is a duplicate by comparing the received asset transfer message to information of previously received asset transfer messages recorded in the log.

20. The apparatus as claimed in claim 15, wherein the transfer-in process further comprises discarding the received asset transfer message if it is determined to be a duplicate.

21. The apparatus as claimed in claim 15, wherein the information recorded in the log comprises a digest of each asset transfer message.

22. The asset store and transfer system as claimed in claim 21, wherein the digest comprises a hash of the respective asset transfer message.

23. The apparatus as claimed in claim 15, further comprising a display operatively connected to the controller, such that the controller can display information including the asset value amount.

24. The apparatus as claimed in claim 23, wherein the display is a touch-screen for receiving user input.

25. The apparatus as claimed in claim 23, further comprising at least one button for receiving user input.

26. The apparatus as claimed in claim 23, wherein the transfer-out process comprises comparing the asset value amount to be transferred to a user-input amount, and generating the asset transfer message only if the asset value amount to be transferred matches the user-input amount.

27. The apparatus as claimed in claim 23, wherein the received asset transfer request message includes an asset value amount to be transferred having a null value, and wherein the transfer-out process comprises generating the asset transfer message using the user-input amount as the asset value amount to be transferred.
